(19) United States
(12) Patent Application Publication
(10) Pub. No.: US 2023/0391342 A1
(43) Pub. Date: Dec. 7, 2023

(54) ROAD SURFACE DAMAGE DETECTION DEVICE, ROAD SURFACE DAMAGE DETECTION METHOD, AND STORAGE DEVICE

(71) Applicant: TOYOTA JIDOSHA KABUSHIKI KAISHA, Aichi-ken (JP)

(72) Inventors: Yosuke KIMURA, Nisshin-shi (JP); Tatsuya OBUCHI, Obu-shi (JP)

(21) Appl. No.: 18/295,850

(22) Filed: Apr. 5, 2023

(30) Foreign Application Priority Data
Jun. 6, 2022 (JP) 2022-091657

(51) Int. Cl. B60W 40/06

(52) U.S. Cl. CPC B60W 40/06; B60W 2400/00; B60W 2552/35; B60W 2556/65

(57) ABSTRACT

The calculation server aggregates the fluctuation per unit time of the physical quantity indicating the behavior of each of the plurality of detected vehicles, the plurality of maximum values by each of the plurality of vehicles in the first predetermined period, the section average fluctuation which is an average value for the plurality of vehicles, and each of the section maximum fluctuation which is a maximum value of the plurality of maximum values in the first predetermined period in a second predetermined period longer than the first predetermined period, and detects the road surface damage location based on the result of removing the noise component from the aggregated result.

### CROSS-REFERENCE TO RELATED APPLICATION

This application claims priority to Japanese Patent Application No. 2022-091657 filed on Jun. 6, 2022, incorporated herein by reference in its entirety.

### BACKGROUND

### 1. Technical Field

The present disclosure relates to a road surface damage detection device, a road surface damage detection method, and a storage medium for detecting a damage portion of a road surface from time-series data related to behaviors of a plurality of vehicles.

### 2. Description of Related Art

The road surface of the road may be deteriorated by traveling of the vehicle or the like, and damage such as a pothole caused by a rut digging in which the road surface is deformed in a groove shape in the traveling direction by the wheels of the traveling vehicle or a partial peeling of the pavement may occur. In particular, the pothole not only causes the tire of the traveling vehicle to puncture, but also may cause an accident. Therefore, it is required to detect and repair the pothole quickly.

However, the detection of a road surface damage such as a pothole mainly depends on the inspection of a road by a person, and it is difficult to say that such an inspection is efficient, and it is not easy to quickly detect the road surface damage that has occurred.

Japanese Unexamined Patent Application Publication No. 2021-086476 (JP 2021-086476 A) discloses a road surface damage detection device, a road surface damage detection method, and a program for detecting a road surface damage based on changes in wheel speeds of a plurality of vehicles.

### SUMMARY

However, in the disclosure described in JP 2021-086476 A, a road surface damage is mainly detected based on whether the maximum fluctuation of the wheel speed is equal to or larger than a threshold value. The maximum fluctuation of the wheel speed can also be detected by a temporary falling object such as gravel, a structure such as a maintenance hole, a lid of the side groove, and a railroad crossing, as well as an avoidance behavior of the vehicle, apart from the road surface damage. Therefore, it may be difficult to distinguish between the case of the road surface damage and the case that does not involve the road surface damage.

In view of the above, it is an object of the present disclosure to provide a road surface damage detection device, a road surface damage detection method, and a storage medium capable of appropriately detecting a road surface damage.

To achieve the above object, a road surface damage detection device according to claim 1 includes: a physical quantity detection unit that detects each physical quantity indicating a behavior of each of a plurality of vehicles; a calculation aggregation unit that aggregates each of a section average fluctuation that is an average value of a fluctuation per unit time of the physical quantity detected by the physical quantity detection unit in a first predetermined period and a section maximum fluctuation that is a maximum value in the first predetermined period with respect to a second predetermined period that is longer than the first predetermined period; a filtering unit that removes a noise component from an aggregation result by the calculation aggregation unit; and a road surface damage detection unit that detects a road surface damage portion based on a result output by the filtering unit.

According to the road surface damage detection device of claim 1, filtering of the analysis data makes it possible to detect the road surface damage based on the data in which the remarkable fluctuation of the physical quantity that can be detected by a temporary falling object such as gravel, a structure such as a maintenance hole, a lid of the side groove, and a railroad crossing, and the avoidance behavior of the vehicle that are different from the road surface damage and that can become noise components is suppressed.

The road surface damage detection device according to claim 2 is the road surface damage detection device according to claim 1, and the filtering unit removes the noise component from the aggregation result by the calculation aggregation unit using a filter including a moving average, a Gaussian filter, and a filter based on deep learning.

According to the road surface damage detection device of claim 2, erroneous detection of the road surface damage is suppressed by smoothing the data before the processing by the filtering.

In the road surface damage detection device according to claim 3, the road surface damage detection unit determines that there is a possibility of road surface damage when the section average fluctuation included in the result output by the filtering unit is equal to or larger than a predetermined first threshold value and the section maximum fluctuation included in the result output by the filtering unit is equal to or smaller than a predetermined second threshold value that is larger than the first threshold value.

According to the road surface damage detection device of claim 3, it is possible to determine the possibility of road surface damage by comparing the section average fluctuation of the physical quantity indicating the behavior of the vehicle with the predetermined threshold value.

In the road surface damage detection device according to claim 4, the road surface damage detection unit determines that a sudden road surface damage has occurred in any of a case where a change amount of the section average fluctuation in unit of the first predetermined period that is included in the result output by the filtering unit is equal to or larger than a predetermined change amount threshold value and a case where a difference between the section maximum fluctuation and the section average fluctuation in the second predetermined period is equal to or larger than a predetermined third threshold value.

According to the road surface damage detection device of claim 4, it is possible to detect the occurrence of the sudden road surface damage based on the mode of the change in the physical quantity indicating the behavior of the vehicle.

In the road surface damage detection device according to claim 5, the road surface damage detection unit determines that a road surface has deteriorated over time when a time-series change in the section average fluctuation included in the result output by the filtering unit increases in a downward convex curved shape, determines that a condition of the road surface is unchanged when the time-series change in the section average fluctuation is flat, and determines that any of cutting work, repair, and replacement of pavement of the road surface has been performed when the time-series change in the section average fluctuation is a stepwise change.

According to the road surface damage detection device of claim 5, it is possible to determine the presence or absence of the road surface damage or the construction work of the road surface based on the mode of the time-series change of the physical quantity indicating the behavior of the vehicle.

In the road surface damage detection device according to claim 6, the physical quantity detection unit is a wheel speed sensor that detects a wheel speed of the vehicle as the physical quantity.

According to the road surface damage detection device of claim 6, it is possible to detect the road surface damage based on the wheel speed detected by the wheel speed sensor universally included in the vehicle.

In the road surface damage detection device according to claim 7, the wheel speed sensor detects a wheel speed of each of four wheels included in the vehicle, and the road surface damage detection unit determines that there is the road surface damage when, in the first predetermined period, a difference between an average value of fluctuations per unit time of the wheel speeds of one of right and left wheels with respect to the vehicles and an average value of fluctuations per unit time of the wheel speeds of the other of the right and left wheels with respect to the vehicles is equal to or larger than a predetermined fourth threshold value.

According to the road surface damage detection device of claim 7, the road surface damage can be detected based on the difference between the wheel speeds independently detected for the four wheels and the right and left wheels.

In the road surface damage detection device according to claim 8, the physical quantity detection unit is an inertia measurement device that detects an angular velocity of an attitude angle of the vehicle and acceleration of the vehicle as the physical quantities.

According to the road surface damage detection device of claim 8, the road surface damage can be detected based on the time-series data of each of the angular velocity of the attitude angle of the vehicle and the acceleration of the vehicle.

In the road surface damage detection device according to claim 9, the physical quantity detection unit is a steering angle sensor that detects a steering angle of the vehicle as the physical quantity.

According to the road surface damage detection device of claim 9, the road surface damage can be detected based on the time-series data of the steering angle of the vehicle.

In the road surface damage detection device according to claim 10, the physical quantity detection unit is a throttle sensor that detects a throttle opening degree indicating deceleration of the vehicle as the physical quantity.

According to the road surface damage detection device of claim 10, the road surface damage can be detected based on the throttle opening degree indicating the deceleration of the vehicle.

In the road surface damage detection device according to claim 11, the physical quantity detection unit is a brake pedal sensor that detects a depression force of a brake pedal indicating deceleration of the vehicle as the physical quantity.

According to the road surface damage detection device of claim 11, the road surface damage can be detected based on the depression force of the brake pedal indicating the deceleration of the vehicle.

To achieve the above object, a road surface damage detection method according to claim 12 includes: a step of detecting each physical quantity indicating a behavior of each of a plurality of vehicles; a step of aggregating each of a section average fluctuation that is an average value of a fluctuation per unit time of the detected physical quantity in a first predetermined period and a section maximum fluctuation that is a maximum value in the first predetermined period with respect to a second predetermined period that is longer than the first predetermined period; a step of removing a noise component from a result of the aggregation; and a step of detecting a road surface damage portion based on the result from which the noise component is removed.

According to the road surface damage detection method of claim 12, filtering of the analysis data makes it possible to detect the road surface damage based on the data in which the remarkable fluctuation of the physical quantity that can be detected by a temporary falling object such as gravel, a structure such as a maintenance hole, a lid of the side groove, and a railroad crossing, and the avoidance behavior of the vehicle that are different from the road surface damage and that can become noise components is suppressed.

A storage medium according to claim 13 stores a road surface damage detection program for achieving the above object, and the road surface damage detection program causes a computer to function as the following configuration.

The configuration includes: a calculation aggregation unit that aggregates each of a section average fluctuation that is an average value of a fluctuation per unit time of a physical quantity indicating a behavior of each of a plurality of vehicles in a first predetermined period and a section maximum fluctuation that is a maximum value in the first predetermined period with respect to a second predetermined period that is longer than the first predetermined period; a filtering unit that removes a noise component from an aggregation result by the calculation aggregation unit; and a road surface damage detection unit that detects a road surface damage portion based on a result output by the filtering unit.

According to the storage medium of claim 13, filtering of the analysis data makes it possible to detect the road surface damage based on the data in which the remarkable fluctuation of the physical quantity that can be detected by a temporary falling object such as gravel, a structure such as a maintenance hole, a lid of the side groove, and a railroad crossing, and the avoidance behavior of the vehicle that are different from the road surface damage and that can become noise components is suppressed.

As described above, according to the road surface damage detection device, the road surface damage detection method, and the storage medium of the present disclosure, it is possible to appropriately detect a road surface damage.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration of a road surface damage detection device according to the present embodiment;

FIG. 2 is a block diagram illustrating a configuration of a vehicle;

FIG. 3 is a block diagram illustrating an example of a specific configuration of a calculation server according to the present embodiment;

FIG. 4 is a functional diagram of a CPU of computing servers according to the present embodiment;

FIG. 5 is a flowchart illustrating an example of processing of the calculation server according to the present embodiment;

FIG. 6 is a schematic diagram illustrating an example of a time-series change in a second predetermined period of section average fluctuation;

FIG. 7 is a schematic diagram illustrating an example of a time-series change in the second predetermined period of the section maximum fluctuation;

FIG. 8 is an explanatory diagram of a case where road surface damage is detected based on differences in wheel speeds of left and right wheels of a vehicle;

FIG. 9 is a sequence diagram illustrating an example of processing of the road surface damage detection device according to the present embodiment.

### DETAILED DESCRIPTION OF EMBODIMENTS

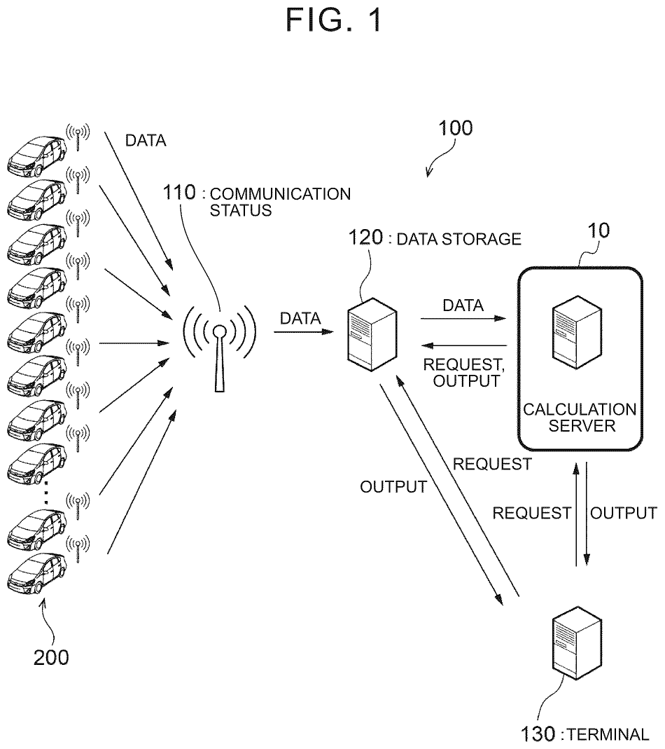

Hereinafter, the road surface damage detection device 100 according to the present embodiment will be described with reference to FIG. 1. The road surface damage detection device 100 illustrated in FIG. 1 includes a communication device 110, a data storage 120, a calculation server 10, and a terminal 130. The communication device 110 acquires data from a plurality of vehicles 200 that are so-called connected cars having a function of constantly connecting to a network. The data storage 120 stores data received by the communication device 110. The calculation server 10 detects road surface damage based on the data accumulated in the data storage 120. The terminal 130 is a terminal capable of browsing information on road surface damage detected by the calculation server 10.

As will be described later, the data storage 120 is a data server including a database. The calculation server 10 is a computer capable of executing advanced arithmetic processing at high speed. Each of the data storage 120 and the calculation server 10 may be a single server, or may be a cloud capable of distributing processing loads. The data storage 120 and the calculation server 10 may be the same server. The terminal 130 is not an essential configuration. For example, if the calculation server 10 includes an input device such as a keyboard and a mouse, and an output device such as a display, the terminal 130 may be omitted.

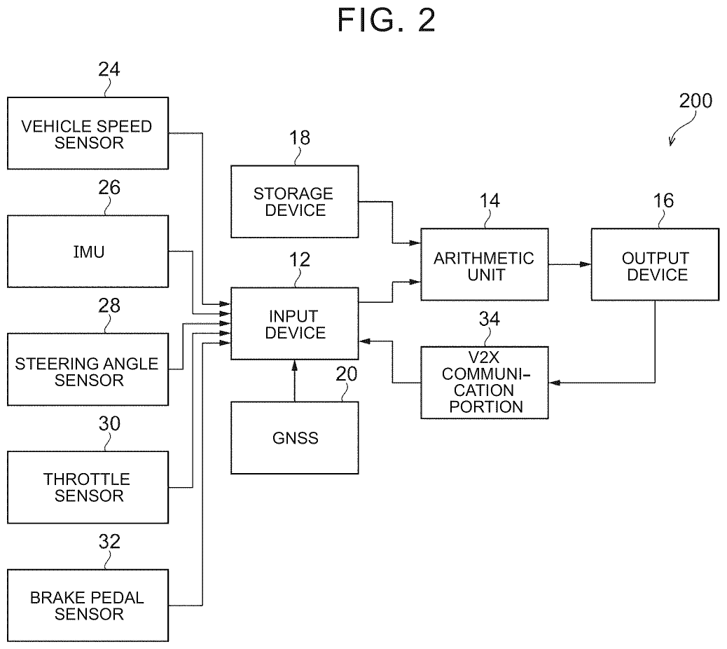

FIG. 2 is a block diagram illustrating a configuration of the vehicle 200. The vehicle 200 includes a storage device 18, a Global Navigation Satellite System (GNSS device 20, an input device 12, an arithmetic device 14, and an output device 16. The storage device 18 stores data necessary for the calculation of the arithmetic device 14 and the calculation result of the arithmetic device 14. The Global Navigation Satellite System (GNSS) device performs position estimation using a signal transmitted from an artificial satellite (hereinafter, abbreviated as “satellite”). The input device 12 receives input of the wheel speed detected by the vehicle speed sensor 24, the angular velocity and acceleration of the attitude angle of the vehicle 200 detected by IMU (inertial measurement device) 26, the steering angle of the vehicle 200 detected by the steering angle sensor 28, the throttle opening degree of the vehicle 200 detected by the throttle sensor, the pedaling force of the brake pedal of the vehicle 200 detected by the brake pedal sensor 32, and the information acquired by V2X communication unit 34 through the wireless communication. The arithmetic device 14 calculates information indicating the behavior of the vehicle 200 such as the wheel speed based on the input data input from the input device 12 and the data stored in the storage device 18, and outputs the information in association with the position information of the vehicle 200 detected by GNSS device 20 or the like. The output device 16 outputs the calculation result of the arithmetic device 14 to V2X communication unit 34. The vehicle speed sensor 24 is configured to be able to detect four wheel speeds of the vehicle 200. In addition to the brake pedal sensor 32, the vehicle 200 may separately include a master cylinder sensor that detects the pressure in the master cylinder of the brake.

As described above, the vehicle 200 is a so-called connected car. However, even if the vehicle 200 is not a connected car, it may be a vehicle to which a post-attached communication device such as a so-called translog that analyzes and utilizes travel data transmitted from an on-board device mounted on the vehicle 200 and various sensors that acquire travel data are post-attached.

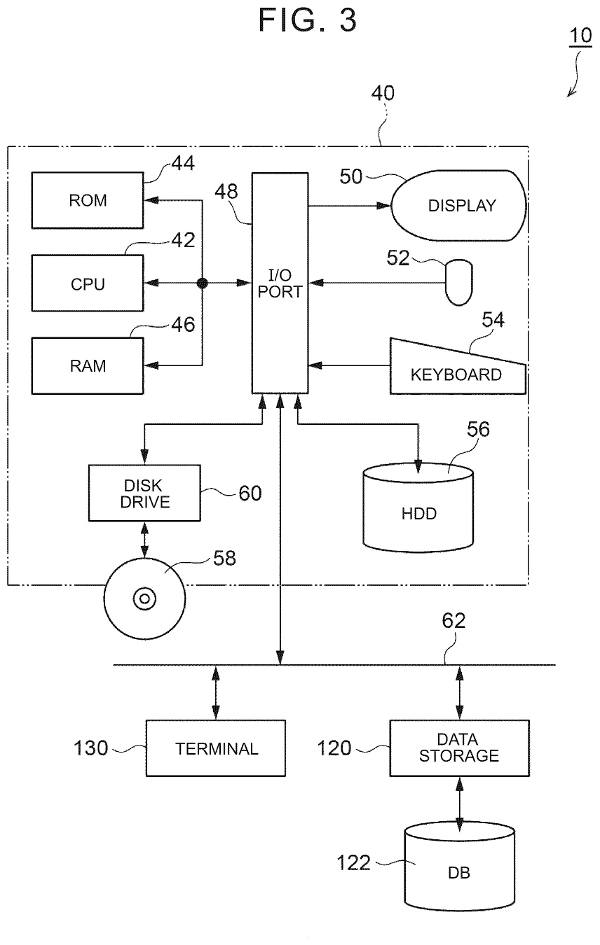

FIG. 3 is a block diagram illustrating an example of a specific configuration of the calculation server 10 according to the embodiment of the present disclosure. The calculation server 10 includes a computer 40. The computer 40 includes a Central Processing Unit (CPU) 42, Read Only Memory (ROM) 44, Random Access Memory (RAM) 46 and an input/output port 48. As an example, it is desirable that the computer 40 is a model capable of executing advanced arithmetic processing at high speed.

In the computer 40, CPU 42, ROM 44, RAM 46 and the input/output ports 48 are connected to each other via various buses such as an address bus, a data bus, and a control bus. The input/output port 48 is connected with a display 50, a mouse 52, a keyboard 54, and a disk drive 60 that reads data from a hard disk (HDD)56 and various disks (e.g., CD-ROM and DVD) 58) as various input/output devices.

A network 62 is connected to the input/output port 48. It is possible to exchange information with various devices connected to the network 62. In the present embodiment, a data storage 120, which is a data server to which a DB)122 is connected, is connected to the network 62. Data can be sent to and received from DB 122.

DB 122 stores time-series data and the like of the plurality of vehicles 200 acquired via the communication device 110. The storage of the data in DB 122 may be registered by the computer 40 or another device connected to the network 62 in addition to the storage via the communication device 110.

The present embodiment will be described assuming that time-series data and the like of a plurality of vehicles 200 are stored in a DB 122 connected to the data storage 120. However, DB 122 data may be stored in an external storage device such as a HDD 56 built in the computer 40 or an external hard disk.

On HDD 56 of the computer 40, a program or the like for detecting road surface damages is installed. In the present embodiment, CPU 42 executes the program to detect road surface damages based on data acquired from the data storage.

There are several methods for installing the program for detecting road surface damage according to the present embodiment in the computer 40. For example, the program is stored in a CD-ROM, a DVD, or the like together with the setup program. Then, the disk is set in the disk drive 60. When the setup program is executed on CPU 42, the program is installed in HDD 46. Alternatively, the program may be installed in HDD 46 by communicating with another information processing device connected to the computer 40 via a public telephone line or the network 62.

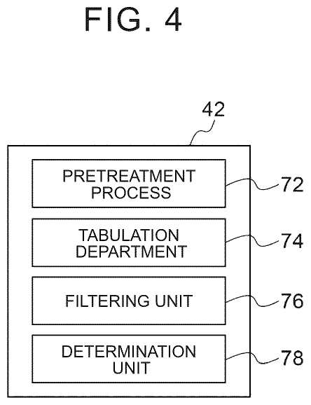

FIG. 4 shows a functional diagram of a CPU 42 of calculation servers 10. Various functions realized by CPU 42 of the calculation server 10 executing a program for detecting road surface damage will be described. The program for detecting road surface damage includes a preprocessing function, an aggregation function, a filtering function, and a determination function. In the pre-processing function, analysis data is prepared. In the aggregation function, a fluctuation of the acquired analysis data, an average value of the fluctuation, a maximum value of the fluctuation, and the like are calculated. In the filtering function, noise or the like is removed by applying a filter to the data processed by the aggregation function. In the determination function, road surface damage is detected. As shown in FIG. 4, CPU 42 functions as a pre-processing unit 72, an aggregation unit 74, a filtering unit 76, and a determination unit 78 in a manner such that the CPU 42 executes program that includes each function and relates to machine learning.

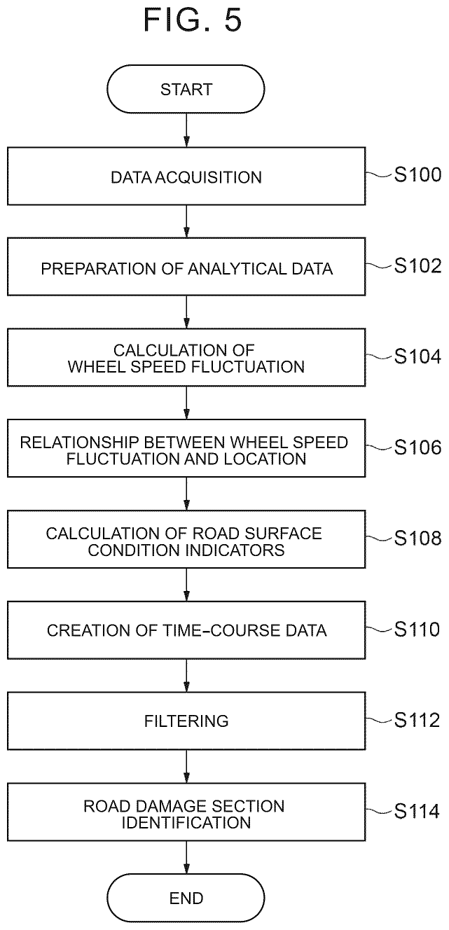

FIG. 5 is a flowchart illustrating an example of processing of the calculation server 10 constituting the road surface damage detection device 100 according to the present embodiment. In S100 of steps, analytical data is obtained from data storage 120.

In the step S102, the pre-processing unit 72 prepares the analytical data. Specifically, the preparation of the analytical data in the step S102 is a process of acquiring, among the time-series data collected by the unspecified number of vehicles 200, information on the wheel speed and the like of the four wheels of the vehicle 200 associated with the position information of the vehicle 200 by dividing the information into first predetermined periods (for example, one day) and acquiring the information for a second predetermined period (for example, 30 days) longer than the first predetermined period. Hereinafter, in the present embodiment, the wheel speeds of four wheels are described as representative of analysis data used for road surface damage detection. However, the analysis data to be used for road surface damage detection is not limited thereto. For example, the analysis data to be used for detecting the road surface damage may be angular velocity and acceleration of the attitude angle of the vehicle 200 detected by IMU 26. Further, the analysis data used for road surface damage detection may be information related to the behavior of the vehicle 200 detected by the steering angle sensor 28, the throttle sensor 30, and the brake pedal sensor 32. The first predetermined period may be from 2 days to 7 days instead of 1 day. The second predetermined period of time may be 31 days to 180 days, etc., instead of 30 days.

In the step S104, the aggregation unit 74 calculates the fluctuation of the wheel speed of the four wheels of the vehicle 200 for each of the wheels every first predetermined period or every trip of the vehicle 200. Wheel speed is difficult to be an effective material for detecting road surface damage at low speed. Therefore, in the present embodiment, the information on the wheel speed equal to or higher than the predetermined speed is provided as analysis data for detecting the road surface damage. The predetermined velocity is, for example, a 15 km/h or the like. The predetermined speed may be a higher speed when detecting road surface damage, such as an expressway with a high speed limit.

In the present embodiment, the road surface damage is detected based on the wheel speed fluctuation. As shown in Equation (1) below, the wheel speed fluctuation is an absolute value (ABS) obtained by processing the change Δ (wheel speed) of the wheel speed per unit time Δt with a high-pass filter (HPF) and removing noises.

Wheel speed fluctuation=ABS(HPF(Δ(wheel speed)/Δt)) (1)

Further, in the step S104, the wheel speed fluctuation maximum value is defined as time-series data in which the maximum value (among the four wheels) of the plurality of vehicles 200 is selected for each time among the wheel speed fluctuations of the four wheels. Then, the maximum value of the wheel speed fluctuation is calculated.

In the step S106, the aggregation unit 74 associates the wheel speed fluctuation with the location. As described above, in the present embodiment, the information on the wheel speed of the vehicle 200 is associated with the position information of the vehicle 200 detected by GNSS device 20 or the like included in the vehicle 200. In the step S106, road-section information for associating the wheel speed fluctuation with the location is acquired. In the step S106, road-section information is mainly acquired in the following manner.
(1) The target area (e.g., the entire area of Toyota City) is divided into assessment intervals (e.g., 10 m×10 m).
(2) The road link information (coordinates of the starting point and the ending point of the road) of the target area (for example, the entire area of Toyota City) is acquired.

Positioning by GNSS often involves errors. Therefore, in the step S108 described later, the error of the positioning is corrected in GNSS by referring to the road-link-information (2). The road link information may be stored in the data storage 120 in advance. Further, the road link information may be acquired from an external server or the like via the communication device 110 or the like. Further, in order to reduce computational loads, the target area is divided into evaluation sections of 10 m×10 m degrees in (1). When the computation capability of the calculation servers 10 is high, the evaluation section may be enlarged more than 10 m×10 m.

In S108 of steps, the aggregation unit 74 calculates the road surface condition index. Specifically, the wheel speed fluctuation and the road section are associated with each other by using latitude and longitude coordinates included in the road link information acquired in the step S106. Then, a road surface condition index is calculated for each evaluation section. The road surface state index in the present embodiment is a section average fluctuation which is an average value of the maximum wheel speed fluctuation values of the plurality of vehicles 200, a section maximum fluctuation which is a maximum value of the maximum wheel speed fluctuation values of the plurality of vehicles 200, and the like. Specifically, the section average fluctuation is a quotient obtained by dividing the sum of the maximum wheel speed fluctuation values in each of the plurality of vehicles 200 by the number of the plurality of vehicles 200. The section maximum fluctuation is the maximum value of the wheel speed fluctuation maximum value of all the vehicles 200.

In the step S108, as the road surface condition index, an average value of the wheel speed fluctuations of each of the four wheels in each of the plurality of vehicles 200 for the plurality of vehicles 200 and a maximum value of the wheel speed fluctuations for each of the four wheels in each of the plurality of vehicles 200 are calculated.

In the step S108, the above-described calculation of the road surface condition index is repeated for “second predetermined period/first predetermined period (for example, 30)” times.

In S110 of steps, the aggregation unit 74 generates time-dependent data. Specifically, the road surface condition index for 30 days, for example, calculated by the step S108 is stored in HDD 56 or the data storage 120 which is a storage device as time-dependent data.

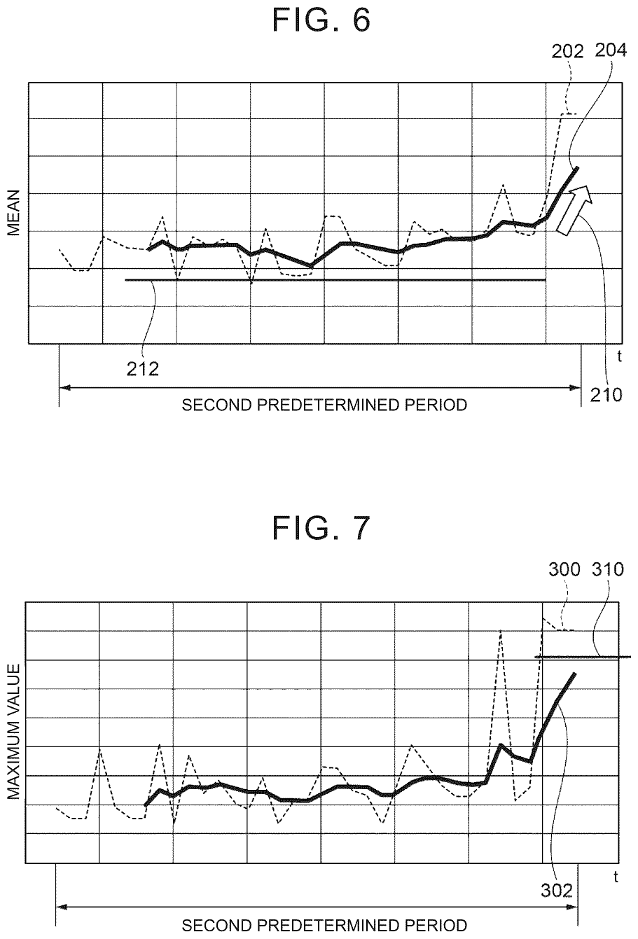

In the step S112, the filtering unit 76 performs a filtering process in order to remove or suppress the noise components of the time-varying data, which is time-series data, to obtain a physical quantity corresponding to the true road surface condition. Filters to be applied in the step S112 include, for example, moving averages, Gaussian filters, and deep learning such as Long short-term memory (LSTM. The moving average includes a simple moving average, a weighted moving average, and an exponential moving average. The moving average may be any moving average such as a simple moving average, a weighted moving average, and an exponential moving average as long as the time-series data can be smoothed by removing a noise component from the time-series data. In addition, in the simple moving average, the weighted moving average, and the exponential moving average, an average value is calculated for the latest predetermined number (n pieces) of data. The predetermined number n is set so that the mode of the time-series data after the moving average processing becomes a state suitable for detecting road surface damage. As illustrated in FIGS. 6 and 7, the state suitable for detecting the road surface loss is a state in which the time-series data is smoothed and the change at every first predetermined period can be confirmed.

In S112 of steps, not only the above-described moving averages but also Gaussian filters, LSTM, or the like may be used. As shown in FIGS. 6 and 7, whether to use the moving averages, the Gaussian filters, and LSTM may be determined based on whether or not each filter is applied to time-series data such that the time-series data is smoothed and the change in each first predetermined period can be confirmed.

In addition, the above filter may be selected according to the road specifications (a difference in road standards such as a trunk road or a living road, or a degree of roughness of a road surface, etc.), and further according to the usage environment of the road (weekly fluctuations such as an increase or decrease in traffic volume on weekends, or monthly fluctuations such as an increase or decrease in traffic volume at an end of the month, etc.). Furthermore, the parameters of the selected filter (a predetermined number n for the moving average, and a predetermined number n or a weight for the weighted moving average) may be set according to the road specification or the use environment.

FIG. 6 is a schematic diagram illustrating an example of a time-series change in the second predetermined period of the section average fluctuation. The broken line shown in FIG. 6 is raw data 202 before filtering of the section average fluctuation in the second predetermined period. The solid line shown in FIG. 6 is the filtered data 204 of the section average fluctuation in the second predetermined period. In the example shown in FIG. 6, a weighted moving average is adopted for the filter. As shown in FIG. 6, the filtered data 204 is smoothed against the raw data 202. Further, the noise component of the filtered data 204 is removed or suppressed.

FIG. 7 is a schematic diagram illustrating an example of a time-series change in the second predetermined period of the section maximum fluctuation. The dashed line shown in FIG. 7 represents raw data 300 before filtering of the section maximum fluctuation in the second predetermined period. The solid line shown in FIG. 7 is the filtered data 302 of the section maximum fluctuation in the second predetermined period. In the example shown in FIG. 7, a weighted moving average is adopted for the filter. As shown in FIG. 7, the filtered data 302 is smoothed against the raw data 300. Further, the noise component of the filtered data 302 is removed or suppressed.

In step S114, the determination unit 78 identifies the road surface damaged section. Specifically, it is determined that there is a possibility of road surface damage when the filtered data 204 of the section average fluctuation illustrated in FIG. 6 is equal to or larger than the predetermined first threshold value 212 and the filtered data 302 of the section maximum fluctuation illustrated in FIG. 7 is equal to or smaller than the predetermined second threshold value 310 that is larger than the first threshold value 212.

When the filtered data 204 of the section average fluctuation is smaller than the predetermined first threshold value 212, it can be determined that the road surface is in a sufficiently clean state. Then, it can be determined that the risk of occurrence of a pothole or the like is small. Further, when the filtered data 302 of the section maximum fluctuation is larger than the predetermined second threshold value 310 larger than the first threshold value 212, it is estimated that the road surface is rough or temporarily gravel in the road cutting work or the like. Therefore, such a case is not included in a case where a road surface damage such as a pothole occurs. As an example, the first threshold value 212 is specifically determined based on the filtered data 204 of the section average fluctuation in the case where the road surface is smooth. In addition, the second threshold value 310 is specifically determined based on the filtered data 302 of the section maximum fluctuation in the case where the road surface is rough in the road cutting work or the like.

When the amount of change from the previous day of the section average fluctuation shown in FIG. 6 (i.e., the amount of change in the unit of the first predetermined period) is equal to or greater than the predetermined change amount threshold value 210, and when the difference between the section maximum fluctuation and the section average fluctuation on the same day (the same first predetermined period) within the second predetermined period is equal to or greater than the predetermined third threshold value, the determination unit 78 determines that a sudden road surface damage has occurred. As an example, each of the change amount threshold value 210 and the third threshold value is specifically determined based on a change in data in a case where a road surface damage occurs abruptly.

Further, the determination unit 78 may specify the road surface damage from the waveform of the section average fluctuation. For example, in a case where the change in the time series of the section average fluctuation increases rightward or exponentially, it is determined that the secular change of the road surface has occurred. The change in the upward slope is a case where a curve indicating a change in the section average fluctuation in time series increases in a downward convex state. A mathematically convex downward curve shows a positive value of the second derivative of the function representing the curve. However, the section average fluctuation shown in FIG. 6 is discrete data. Therefore, the section average fluctuation shown in FIG. 6 is not differentiatable. As an example, in the present embodiment, by examining the second derivative of the differentiatable function obtained approximately by performing the curve fitting to the change in the time series of the section average fluctuation as shown in FIG. 6, it is determined whether or not the curve indicating the change in the time series of the section average fluctuation is convex downward.

In addition, when the curve indicating the change in the section average fluctuation in time series is flat, the determination unit 78 determines that the state of the road surface is unchanged. When the curve indicating the time-series change of the section average fluctuation changes in a stepwise manner, the determination unit 78 determines that any one of the cutting work, the repair, and the pavement replacement of the road surface has been performed. The above-described mechanisms of determination based on waveforms can be constructed by deep learning such as LSTM, for example.

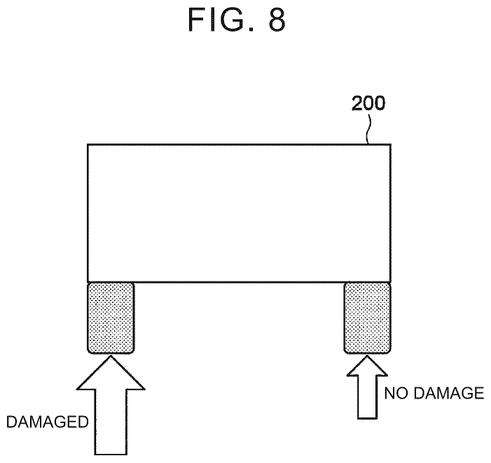

Furthermore, the determination unit 78 may detect the road surface damage based on the difference in the wheel speed fluctuation between the left and right wheels of the vehicle 200. FIG. 8 is an explanatory diagram of a case where road surface damage is detected based on differences in wheel speeds of left and right wheels of the vehicle 200. As shown in FIG. 8, when the road surface is damaged, the wheel speed fluctuation becomes larger than when the road surface is not damaged. As an example, in the present embodiment, it is determined that there is road surface damage when, in the first predetermined period, the difference between the average value of the plurality of vehicles 200 of the fluctuation of the wheel speed on one side and the average value of the plurality of vehicles 200 of the fluctuation of the wheel speed on the other side is equal to or greater than a predetermined fourth threshold value. Since the damage of the pothole or the like occurring on the road surface is about 20 cm from the passing 15 cm, it may be detected only on either of the left and right wheels, and thus it is determined that there is the road surface damage as described above. As an example, the fourth threshold value is specifically determined based on a change in data when any of the left and right wheels ride on a road surface damage such as a pothole.

As described above, in the present embodiment, the road surface damage is detected on the basis of the fluctuation of the wheel speed of the vehicle 200 as an example. The analysis data for detecting road surface damage is not limited to fluctuations in the wheel speed of the vehicle 200. As described above, the time-series data of the angular velocity and the acceleration of the attitude angle of the vehicle 200 detected by IMU 26 may be treated as the analytical data. Hereinafter, a case will be described in which, for example, the acceleration of the vehicle 200 in the Z-axis direction (vertical direction of the vehicle 200) is used as analysis data as data that is significantly susceptible to the influence of road surface damage among the data of the angular velocity of the attitude angle of the vehicle 200 and the acceleration when the wheels of the vehicle 200 ride on a pothole or the like on the road surface.

In this case, the aggregation unit 74 calculates the fluctuation of the acceleration of the vehicle 200 in the Z-axis direction (hereinafter, abbreviated as “acceleration fluctuation”) every first predetermined period or every trip of the vehicle 200. The acceleration fluctuation is an absolute value (ABS) obtained by processing a change Δ (acceleration) of acceleration per unit time Δt with a high-pass filter (HPF) and removing noises, as shown in Equation (2) below.

Acceleration fluctuation=AB S(HPF(Δ(acceleration)/Δt)) (2)

Further, the aggregation unit 74 defines and calculates the maximum acceleration fluctuation value as time-series data in which the maximum values of the plurality of vehicles 200 are selected for each time among the acceleration fluctuations.

The acceleration fluctuation and the maximum acceleration fluctuation value calculated as described above are associated with a location (road link information) in the aggregation unit 74 in the same manner as in the case of the wheel speed fluctuation. Then, the road surface state index is calculated. Specifically, the acceleration fluctuation and the road section are associated with each other using latitude and longitude coordinates included in the road link information. Then, a road surface condition index is calculated for each evaluation section. The road surface state index in the present embodiment is a section average acceleration fluctuation which is an average value of the maximum acceleration fluctuation values of the plurality of vehicles 200, a section maximum acceleration fluctuation which is a maximum value of the maximum acceleration fluctuation values of the plurality of vehicles 200, and the like. Specifically, the section average acceleration fluctuation is a quotient obtained by dividing the sum of the maximum acceleration fluctuation values in each of the plurality of vehicles 200 by the number of the plurality of vehicles 200. The section maximum acceleration fluctuation is the maximum value of the wheel speed fluctuation maximum value of all the vehicles 200.

The calculated section average acceleration fluctuation and the section maximum acceleration fluctuation are subjected to a filtering process for removing or suppressing a noise component in a filtering unit. As described above, the filters to be applied are moving averages, Gaussian filters, deep learning such as LSTM, and the like.

As a result of the filtering process, as in the filtered data 204 shown in FIG. 6, the section maximum acceleration fluctuation is smoothed as in the filtered data 302 shown in FIG. 7, and a noise component is removed or suppressed.

Then, the determination unit 78 identifies the road surface damage section based on the smoothed section average acceleration fluctuation and the section maximum acceleration fluctuation. Specifically, it is determined that there is a possibility of road surface damage when the filtered data of the section average acceleration fluctuation is equal to or larger than a predetermined first threshold value and the filtered data of the section maximum acceleration fluctuation is equal to or smaller than a predetermined second threshold value that is larger than the first threshold value.

When the filtered data of the section average acceleration fluctuation is smaller than the predetermined first threshold value, it can be determined that the road surface is in a sufficiently clean state. Then, it can be determined that the risk of occurrence of a pothole or the like is small. In addition, when the filtered data of the section maximum acceleration fluctuation is larger than the predetermined second threshold value larger than the first threshold value, it is estimated that the road surface is rough or temporarily graveled in the road cutting work or the like. Therefore, such a case is not included in a case where a road surface damage such as a pothole occurs.

When the change amount from the previous day of the section average acceleration change (that is, the change amount in the unit of the first predetermined period) is equal to or larger than the predetermined change amount threshold value, or when the difference between the section maximum acceleration change and the section average acceleration change on the same day (the same first predetermined period) within the second predetermined period is equal to or larger than the predetermined third threshold value, the determination unit 78 determines that a sudden road surface damage has occurred.

Further, the determination unit 78 may specify the road surface damage from the waveform of the section average acceleration fluctuation. For example, in a case where the change in the time series of the section average fluctuation increases rightward or exponentially, it is determined that the secular change of the road surface has occurred.

When the curve indicating the change in the interval average acceleration fluctuation in time series is flat, the determination unit 78 determines that the state of the road surface does not change. When the curve indicating the time-series change of the section average acceleration fluctuation changes in a stepwise manner, the determination unit 78 determines that any one of the cutting work, the repair work, and the pavement replacement of the road surface has been performed.

As described above, the road surface damages can be detected on the basis of the accelerations in the Z-axis direction of the vehicles 200 detected by IMU 26. In addition to the acceleration in the Z-axis direction, IMU 26 can detect the acceleration in the X-axis direction (the front-rear direction of the vehicle 200), the acceleration in the Y-axis direction (the lateral direction of the vehicle 200), the angular velocity in the pitch direction of the vehicle 200, the angular velocity in the roll direction, and the angular velocity in the yaw direction. Therefore, the road surface damage may be detected by using the fluctuation of the acceleration and the fluctuation of the angular velocity.

In addition, as described above, information related to the behavior of the vehicle 200 detected by the steering angle sensor 28, the throttle sensor 30, and the brake pedal sensor 32 may be provided to detect road surface damage. In such a case, for example, road surface damage is detected based on the fluctuation of the steering angle of the vehicle 200 detected by the steering angle sensor 28. This is because, in many cases, the driver attempts an avoidance exercise when the driver recognizes road surface damage forward. Also, if the driver recognizes road damage ahead, the driver often decelerates the vehicle 200. Therefore, the road surface damage may be detected from the respective fluctuation amounts in the case where the throttle opening degree detected by the throttle sensor 30 fluctuates in the decreasing direction or in the case where the pedaling force of the brake pedal detected by the brake pedal sensor 32 fluctuates in the increasing direction.

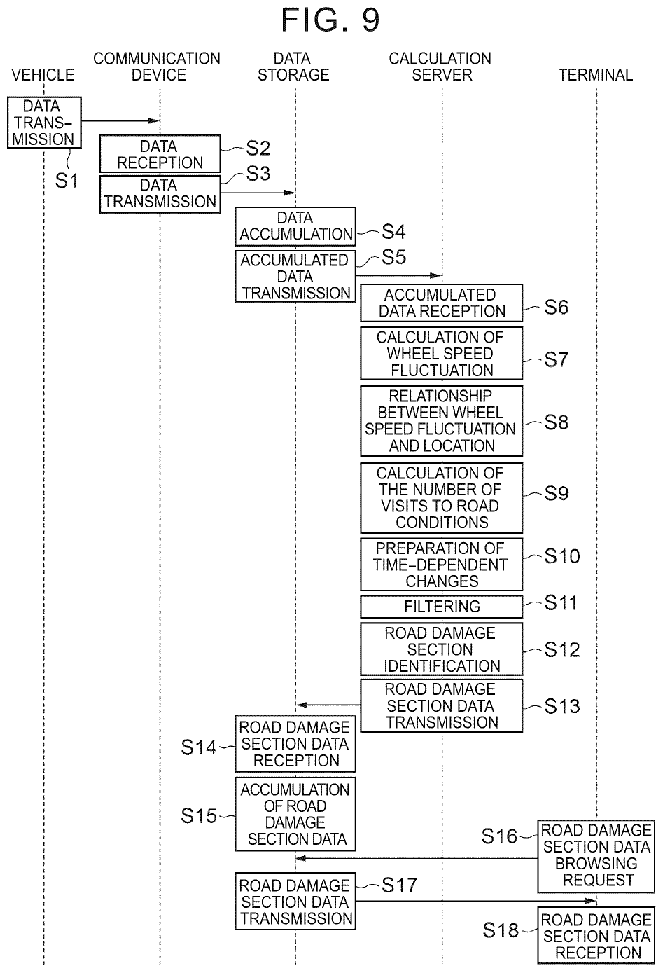

FIG. 9 is a sequence diagram illustrating an example of processing performed by the road surface damage detection device 100 according to the present embodiment. In the step S1, data of the wheel speed detected by the vehicle speed sensor 24, data of the angular velocity of the attitude angle of the vehicle 200 detected by IMU 26, data of the acceleration, data of the steering angle of the vehicle 200 detected by the steering angle sensor 28, data of the throttle opening degree of the vehicle 200 detected by the throttle sensor 30, data of the pedal force of the brake pedal detected by the brake pedal sensor 32, and the like are transmitted from the plurality of vehicles 200.

In the step S2, the communication device 110 receives data transmitted from the plurality of vehicles 200. In a step S3, the received data is transmitted to the data storage 120.

In the step S4, the data received by the data storage 120 is accumulated. The data storage 120 transmits the accumulated data to the calculation servers 10 in the step S5.

In S6 of steps, the calculation servers 10 receive the stored data. Then, in the step S7, the calculation server 10 calculates, for example, a wheel speed fluctuation. If IMU 26 is used to detect the road damage, the angular velocity of the attitude angle of the vehicle 200 or the acceleration of the vehicle 200 is calculated. In addition, the fluctuation of the time-series data detected by each of the steering angle sensor 28, the throttle sensor 30, and the brake pedal sensor 32 of the vehicle 200 is calculated.

In the step S8, the calculation server 10 associates the wheel speed fluctuation with the location (road-link-information). In the step S8, the fluctuation and the location of the angular velocity of the attitude angle of the vehicle 200, the fluctuation and the location of the acceleration of the vehicle 200, and the fluctuation and the location of the time-series data detected by each of the steering angle sensor 28, the throttle sensor 30, and the brake pedal sensor 32 of the vehicle 200 may be associated with each other.

In the step S9, the calculation server 10 calculates the road surface condition index. Specifically, the wheel speed fluctuation (or the fluctuation of the angular velocity of the attitude angle of the vehicle 200, the fluctuation of the acceleration of the vehicle 200, or the fluctuation of the behavior of the vehicle 200) and the road section are associated with each other by using the latitude and longitude coordinates included in the road link information acquired in the step S8. Then, a road surface condition index is calculated for each evaluation section.

In S10 of steps, the calculation server 10 generates time-dependent data. The created temporal change data is stored in HDD 56 or the data storage 120, which is a storage device.

In the step S11, the calculation server 10 performs a filtering process for removing or suppressing the noise components of the time-series data that is time-series data.

In the step S12, the calculation server 10 identifies the road surface damaged section. In the step S13, the road surface damaged section data is transmitted to the data storage 120.

In step S14, the data storage 120 receives road damage section data. The road surface damaged section received in the step S15 is accumulated.

In the step S16, the terminal 130 transmits a request to view the road surface damaged section data. The road damage section data browsing request may be made via the calculation server 10. When the road surface damage section data is stored in HDD 56 or the like of the calculation server 10, a road surface damage section data browsing request may be transmitted to the calculation server 10.

In the step S17, the data storage 120 transmits the road surface damage section data in response to the road surface damage section data browsing request from the terminal 130.

In S18 of steps, the terminal 130 receives the road surface damaged section data from the data storage 120.

As described above, the present embodiment detects road surface damage based on so-called big data obtained from a large number of vehicles 200. The big data to be used for detecting road surface damage in the present embodiment is a physical quantity related to the behavior of the vehicle 200, such as the fluctuation of the wheel speed of the four wheels of the vehicle 200 detected by the vehicle speed sensor 24, the fluctuation of the angular velocity of the attitude angle of the vehicle 200 detected by IMU 26, the fluctuation of the acceleration, the fluctuation of the steering angle of the vehicle 200 detected by the steering angle sensor 28, the fluctuation of the throttle opening degree detected by the throttle sensor 30, and the fluctuation of the brake pedal depression force detected by the brake pedal sensor 32 in each of the plurality of vehicles 200. In the present embodiment, road surface damage is detected by comparing the fluctuation of the physical quantity with a predetermined threshold value.

Raw data of physical quantities, e.g., fluctuations in wheel speed, calculated based on the output from each sensor includes noise components that can cause false detections of road surface damage. In the present embodiment, filters such as moving averages, Gaussian filters, and LSTM are applied, and the raw data is smoothed, thereby suppressing noise components. By the filtering process, in the present embodiment, a remarkable change in the physical quantity that can be detected by a temporary falling object such as gravel, a structure such as a manhole, a lid of a side groove, and a railroad crossing, and an avoidance behavior of a vehicle, other than the road surface damage, is suppressed.

Further, the avoidance behavior of the vehicle 200 or a temporary fluctuation of the physical quantity due to a falling object or the like on the road surface, and a permanent fluctuation of the physical quantity due to a structure such as a manhole, a lid of a side groove, and a railroad crossing are considered as causes of generation of a noise component. In the present embodiment, the physical quantity is compared with a plurality of different thresholds, or the change in the waveform of the physical quantity in time series is examined, so that the influence of the noise component at the time of detecting the road surface damage is suppressed.

For example, it is determined that there is a possibility of road surface damage when a section average fluctuation, which is an average value for the plurality of vehicles, of a plurality of maximum values per unit time of the detected physical quantity included in the filtered data in each of the plurality of vehicles in the first predetermined period is equal to or larger than a predetermined first threshold value and a section maximum fluctuation, which is a maximum value in the plurality of vehicles 200 of the fluctuation of the physical quantity indicating the behavior of the vehicle 200 in the first predetermined period included in the filtered data is equal to or smaller than a predetermined second threshold value larger than the first threshold value. The first threshold value assumes a state in which the road surface is smooth. If the fluctuation of the physical quantity indicating the behavior of the vehicle 200 is smaller than the first threshold value, it can be determined that there is no road surface damage. The second threshold value assumes a case where the road surface becomes extremely rough due to road construction or the like. When the fluctuation of the physical quantity indicating the behavior of the vehicle 200 is larger than the second threshold value, it can be estimated that the fluctuation is not due to road surface damage but due to road construction.

In addition, it is determined that a sudden road surface damage has occurred in a case where the amount of change in the section average fluctuation in the first predetermined period unit included in the filtered data is equal to or larger than the predetermined change amount threshold value, and in a case where the difference between the section maximum fluctuation and the section average fluctuation in the same first predetermined period is equal to or larger than the predetermined third threshold value. As described above, in the present embodiment, it is possible to detect the occurrence of the sudden road surface damage based on the mode of the change in the physical quantity indicating the behavior of the vehicle 200.

In addition, it is determined that the road surface has deteriorated over time in a case where the change in the time series of the section average fluctuation increases with a downward convex curve shape. When the change in the time series of the section average fluctuation is flat, it is determined that the state of the road surface is unchanged. When the change in the time series of the section average fluctuation is changed in a stepwise manner, it is determined that any one of the cutting work, the repair work, and the pavement replacement of the road surface has been performed. As described above, in the present embodiment, the presence or absence of road surface damage or road surface construction can be determined according to the mode of time-series change in the physical quantity indicating the behavior of the vehicle 200.

Further, in the present embodiment, when the physical quantity indicating the behavior of the vehicle 200 is the average value of the fluctuation of the wheel speed independently detected by the four wheels, the road surface damage can be detected based on the difference between the left and right wheels.

Note that the “physical quantity detection unit” described in the claims corresponds to the “vehicle speed sensor 24”, “IMU 26”, “steering angle sensor 28”, “throttle sensor 30”, and “brake pedal sensor 32” described in the detailed explanation of the specification. Further, the “calculation aggregation unit” described in the claims corresponds to the “aggregation unit 74” described in the detailed description of the disclosure of the specification. The “road surface damage detection unit” described in the claims corresponds to the “determination unit 78” described in the detailed description of the disclosure of the specification.

Note that the processes executed by CPU reading the software (program) in the above embodiments may be executed by various processors other than CPU. Field-Programmable Gate Array (FPGA) Programmable Logic Device (PLD) in which the circuit configuration can be changed after manufacturing, for example, and dedicated electric circuits or the like, which are processors having a circuit configuration designed specifically for executing a particular process, such as Application Specific Integrated Circuit (ASIC), are exemplified as processors in this instance. Processing may also be performed by one of these various processors. The process may be performed in a combination of two or more processors (e.g., a plurality of FPGA, a combination of CPU and FPGA, etc.) of the same or different type. Further, the hardware configuration of the various processors is, more specifically, an electric circuit in which circuit elements such as semiconductor devices are combined.

In the above embodiments, the program is stored (installed) in the disk drive 60 or the like in advance, but the present disclosure is not limited thereto. The program may be provided in a form stored in a non-transitory (non-transitory) storage medium such as Compact Disk Read Only Memory (CD-ROM), Digital Versatile Disk Read Only Memory (DVD-ROM), and Universal Serial Bus (USB). Further, the program may be downloaded from an external device via a network.

### APPENDIX 1

An information processing device includes: a memory; and at least one processor connected to the memory. The processor is configured to aggregate each of a section average fluctuation that is an average value of a fluctuation per unit time of a physical quantity indicating a detected behavior of each of a plurality of vehicles in a first predetermined period and a section maximum fluctuation that is a maximum value in the first predetermined period with respect to a second predetermined period that is longer than the first predetermined period; remove a noise component from a result of the aggregation; and detect a road surface damage portion based on the result from which the noise component is removed.

What is claimed is:

1. A road surface damage detection device comprising:
a physical quantity detection unit that detects each physical quantity indicating a behavior of each of a plurality of vehicles;
a calculation aggregation unit that aggregates each of a section average fluctuation that is an average value of a fluctuation per unit time of the physical quantity detected by the physical quantity detection unit in a first predetermined period and a section maximum fluctuation that is a maximum value in the first predetermined period with respect to a second predetermined period that is longer than the first predetermined period;
a filtering unit that removes a noise component from an aggregation result by the calculation aggregation unit; and
a road surface damage detection unit that detects a road surface damage portion based on a result output by the filtering unit.

2. The road surface damage detection device according to claim 1, wherein the filtering unit removes the noise component from the aggregation result by the calculation aggregation unit using a filter including a moving average, a Gaussian filter, and a filter based on deep learning.

3. The road surface damage detection device according to claim 2, wherein the road surface damage detection unit determines that there is a possibility of road surface damage when the section average fluctuation included in the result output by the filtering unit is equal to or larger than a predetermined first threshold value and the section maximum fluctuation included in the result output by the filtering unit is equal to or smaller than a predetermined second threshold value that is larger than the first threshold value.

4. The road surface damage detection device according to claim 3, wherein the road surface damage detection unit determines that a sudden road surface damage has occurred in any of a case where a change amount of the section average fluctuation in unit of the first predetermined period that is included in the result output by the filtering unit is equal to or larger than a predetermined change amount threshold value and a case where a difference between the section maximum fluctuation and the section average fluctuation in the second predetermined period is equal to or larger than a predetermined third threshold value.

5. The road surface damage detection device according to claim 3, wherein the road surface damage detection unit determines that a road surface has deteriorated over time when a time-series change in the section average fluctuation included in the result output by the filtering unit increases in a downward convex curved shape, determines that a condition of the road surface is unchanged when the time-series change in the section average fluctuation is flat, and determines that any of cutting work, repair, and replacement of pavement of the road surface has been performed when the time-series change in the section average fluctuation is a stepwise change.

6. The road surface damage detection device according to claim 4, wherein the physical quantity detection unit is a wheel speed sensor that detects a wheel speed of the vehicle as the physical quantity.

7. The road surface damage detection device according to claim 6, wherein:
the wheel speed sensor detects a wheel speed of each of four wheels included in the vehicle; and
the road surface damage detection unit determines that there is the road surface damage when, in the first predetermined period, a difference between an average value of fluctuations per unit time of the wheel speeds of one of right and left wheels with respect to the vehicles and an average value of fluctuations per unit time of the wheel speeds of the other of the right and left wheels with respect to the vehicles is equal to or larger than a predetermined fourth threshold value.

8. The road surface damage detection device according to claim 4, wherein the physical quantity detection unit is an inertia measurement device that detects an angular velocity of an attitude angle of the vehicle and acceleration of the vehicle as the physical quantities.

9. The road surface damage detection device according to claim 4, wherein the physical quantity detection unit is a steering angle sensor that detects a steering angle of the vehicle as the physical quantity.

10. The road surface damage detection device according to claim 4, wherein the physical quantity detection unit is a throttle sensor that detects a throttle opening degree indicating deceleration of the vehicle as the physical quantity.

11. The road surface damage detection device according to claim 4, wherein the physical quantity detection unit is a brake pedal sensor that detects a depression force of a brake pedal indicating deceleration of the vehicle as the physical quantity.

12. A road surface damage detection method comprising:
a step of detecting each physical quantity indicating a behavior of each of a plurality of vehicles;
a step of aggregating each of a section average fluctuation that is an average value of a fluctuation per unit time of the detected physical quantity in a first predetermined period and a section maximum fluctuation that is a maximum value in the first predetermined period with respect to a second predetermined period that is longer than the first predetermined period;
a step of removing a noise component from a result of the aggregation; and
a step of detecting a road surface damage portion based on the result from which the noise component is removed.

13. A non-transitory storage medium storing a road surface damage detection program that causes a computer to function as a configuration comprising:
a calculation aggregation unit that aggregates each of a section average fluctuation that is an average value of a fluctuation per unit time of a physical quantity indicating a behavior of each of a plurality of vehicles in a first predetermined period and a section maximum fluctuation that is a maximum value in the first predetermined period with respect to a second predetermined period that is longer than the first predetermined period;
a filtering unit that removes a noise component from an aggregation result by the calculation aggregation unit; and
a road surface damage detection unit that detects a road surface damage portion based on a result output by the filtering unit.
